(19) United States
(12) Patent Application Publication
(10) Pub. No.: US 2006/0212463 A1
(43) Pub. Date: Sep. 21, 2006

(54) Method and apparatus for extracting metadata information from an application

(76) Inventors: Jens Ole Jensen, Albertslund (DK); Dorte Jacobsen, Birkeroed (DK); Lars Dragheim Olsen, Karlslunde (DK); Michael Fruergaard Pontoppidan, Lynge (DK)

Correspondence Address: MARSHALL, GERSTEIN & BORUN LLP (MICROSOFT), 233 SOUTH WACKER DRIVE, 6300 SEARS TOWER, CHICAGO, IL, 60606, US

(21) Appl. No.: 11/080,774

(22) Filed: Mar. 15, 2005

(51) Int. Cl. G06F 17/00

(52) U.S. Cl. 707/101

(57) ABSTRACT

A metadata driven system for allowing various applications to extract metadata information about an application provides a method of storing metadata about the application, an apparatus for extracting metadata information about the application and an apparatus for converting the metadata information about the application into a form usable by the various applications. The metadata driven system allows updates made to the application to be conveyed to one or more of the other applications using metadata. Any of the various applications extracting the metadata information of the application may be connected to the application via a communication network, such as the Internet. An implementation of the metadata driven system allows an online help system to extract metadata information about the application and to use the metadata information to provide online help related to the application.

### TECHNICAL FIELD

This patent relates generally to computer software and more particularly to business application software using the Internet.

### BACKGROUND

Modern day businesses cannot function efficiently without use of state of the art technology. Specifically, computers and software are an almost essential part of most of the businesses in developed economies. Typically, businesses use a number of off the shelf business applications, such as Excel® as well as a number of custom applications specifically designed for a particular aspect of the business. There are a number of industry specific software applications that are developed by software companies to be used in a particular type of businesses, such as financial services, medical services, etc.

While such industry specific software applications are generally designed with specific characteristics of particular type of business in mind, they still need to be modified to be more suitable for use by the end user. For example, customer relationship management (CRM) software is one such example of a business application that is often modified by either the end user or by an independent software vendor specializing in this particular type of software.

Typically, when software developers ship a software application to an end user, they also provide help information about using, maintaining and debugging the software. In its earliest form, help information was generally provided by user manuals, user guides, etc., in a paper format. Increasingly, help information for software is provided in the electronic format in the form of a text file, as an interactive GUI resource, etc. With the development of the Internet, businesses typically use web based applications to provide distributed business solution on the Internet. Various software developers also provide help information for software using the Internet via, for example, the world-wide web.

Most business applications are generally highly customizable applications that can be customized by each customer with their unique needs. Typical customizations include addition of attributes to an existing entity, adding new entities, renaming or re-labeling one or more entities, etc. When applications are customized, the list of entities, their properties and their relationships may change from their original properties and relationships. If an application for which a central server is used to provide help information over the Internet, when there are changes made to the application locally, it is a challenge to keep the central help server up-to-date with the changes made locally. Moreover, when one central server is used to provide help information to a number of users and when each of the number of users makes different modifications to their own local applications, it becomes extremely difficult to incorporate these changes into the help information resources located at the central location.

Moreover, this problem with the lack of consistency between online resource and a local resource is not only limited to online help and a user interface. Even for two or more applications that are located on a same machine, if there is a change made to one of such applications, it is difficult to communicate such changes to the other local applications. Therefore, there is a need to provide a consistent means for exchanging information regarding customization or other changes made to an application.

### SUMMARY

A metadata driven system for allowing various applications to extract metadata information about an application provides a method of storing metadata about the application, an apparatus for extracting metadata information about the application and an apparatus for converting the metadata information about the application into a form usable by the various applications. The metadata driven system allows updates made to the application to be conveyed to one or more of the other applications using metadata. Any of the various applications extracting the metadata information of the application may be connected to the application via a communication network, such as the Internet.

An implementation of the metadata driven system allows an online help system to extract metadata information about an application and to use the metadata information to provide online help related to the application. The metadata driven online help system is able to provide help information to users of a number of different versions of an application, thus allowing each user to make updates to the application as needed for particular needs. This is extremely useful for business applications that frequently need to be updated according to end user's particular business needs.

An alternate implementation of the metadata driven system allows a user interface system to extract metadata information about an application and to use the metadata information to provide user interface that is automatically updated to reflect any changes in the application. The metadata driven user interface system automatically incorporates any changes or updates made to various properties of entities used in the application into the user interfaces provided presented to the users. Therefore, there is no need for a user to update the user interface code every time the underlying application is modified. An alternate implementation of the metadata driven system may be used for any one application to extract metadata related to another application and use the extracted metadata to provide one or more services.

### BRIEF DESCRIPTION OF DRAWINGS

FIG. 1 is a block diagram of a network interconnecting a plurality of computing resources;

FIG. 2 is a block diagram of a computer that may be connected to the network of FIG. 1;

FIG. 3 illustrates a schematic diagram of a metadata driven online help system that allows a user to receive online help information;

FIG. 4 illustrates a flowchart of the functioning of the metadata driven online help system illustrated in FIG. 3;

FIG. 5 is a schematic diagram illustrating the functioning of the metadata driven online help system illustrated in FIG. 3;

FIG. 6 illustrates a schematic diagram of a metadata driven user interface system to provide user interface to an application; and

FIG. 7 is a schematic diagram illustrating the functioning of the metadata driven user interface system illustrated in FIG. 6.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

### Network

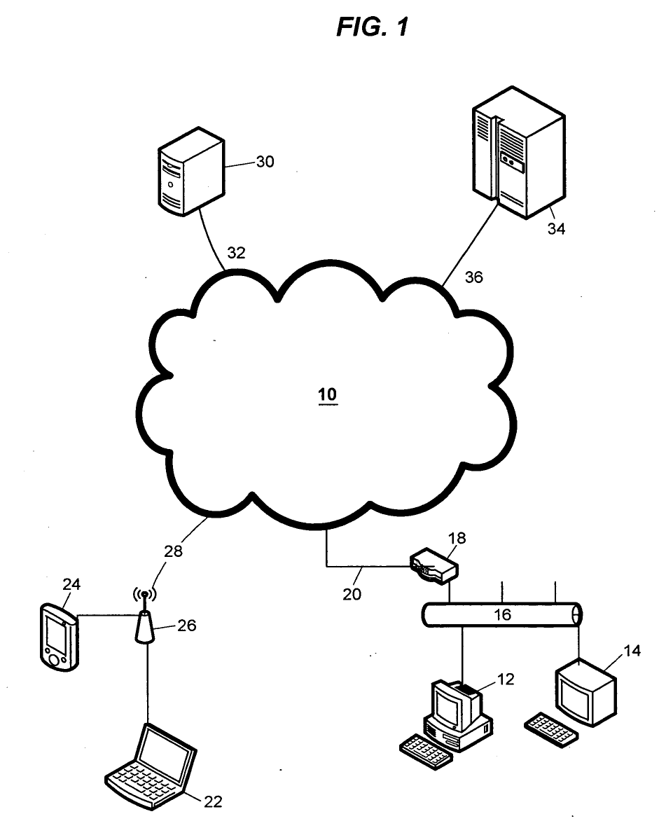

FIG. 1 illustrates a network 10 that may be used to implement an XML versioning system described herein. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. As it will be described below in further detail, one or more components of the dynamic software provisioning system may be stored and operated on any of the various devices connected to the network 10.

### Computer

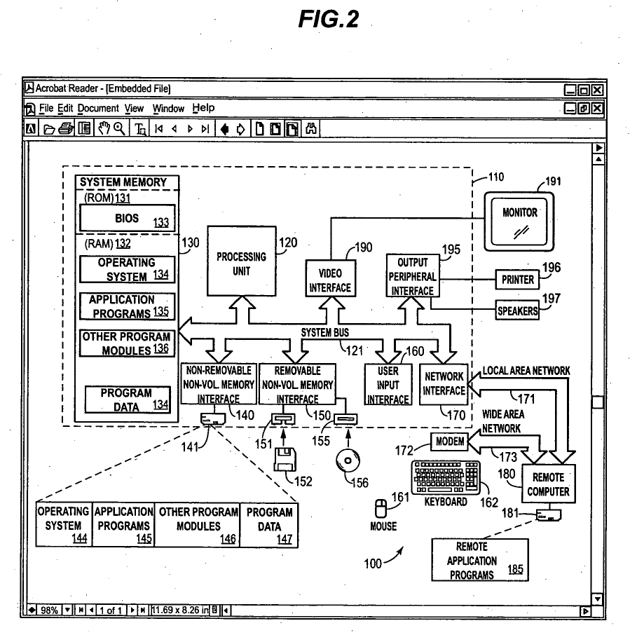

FIG. 2 illustrates a computing device in the form of a computer 110 that may be connected to the network 10 and used to implement one or more components of the dynamic software provisioning system. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

### Metadata Driven Online Help System

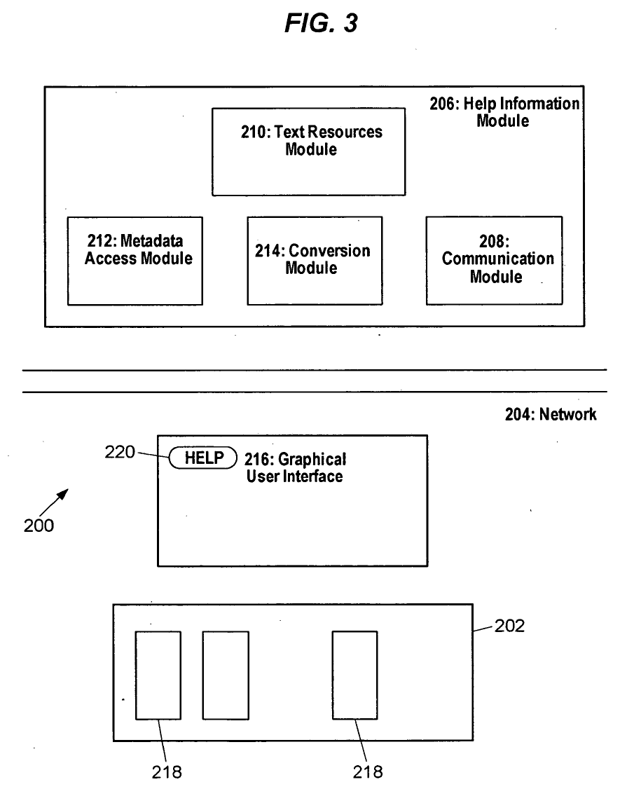

FIG. 3 illustrates a schematic diagram of an online help system 200 that allows a user of an application 202 to receive online help information. Specifically, the online help system 200 may provide help information over a network 204, which may be the Internet, or any network such as the network 10, discussed above in FIG. 1. The online help system 200 includes a help information module 206 that is communicatively connected to the network 204 via a communication module 208. Furthermore, the help information module 206 includes a text resource module 210, a metadata access module 212 and a conversion module 214. While the online help system 200 is shown to be providing help information to only one application 202, however, in an alternate embodiment a number of applications running on different nodes connected to the network 204 may access the help information module 206 to receive online help.

The application 202 may be a customer relation management (CRM) application, a human resource (HR) application, etc. FIG. 3 illustrates a graphical user interface (GUI) window 216 that may be used by a user to interact with the application 202. The application 202 may use a plurality of objects 218, each of the plurality of objects 218 including one or more tables, forms, routines, etc., attached to it. The application 202 may be changed a number of times, each of the changes including a change to the tables attached to the object, the routines attached to the tables, the forms attached to the tables, etc.

A user may interact with one or more of the plurality of objects 218 using the GUI window 216. For example, a user may display a particular table related to one of the objects 218 in the GUI window 216 and input values to that particular table. The GUI window 216 may also include a help button 220 that can be selected by a user to get help information on one of the plurality of objects 218 and display the help information in the GUI window 216. The application 202 may be designed in a manner such that upon selection of the help button 220, the user is connected to the help information module 206. This may be accomplished, for example, by generating a request directed to the universal resource locator (URL) of the server hosting the help information module 206.

Furthermore, the application 202 may be designed in a manner such that the help information request sent to the help information module 206 also specifies the topic for which help information is requested. For example, if a user is currently working with a payment window, help information related to the payment information may be requested from the help information module 206. Alternatively, the application 202 may be designed so that upon selection of the help button 220, a menu may be presented to the user to allow the user to select the topic for which the help information needs to be requested from the help information module 206.

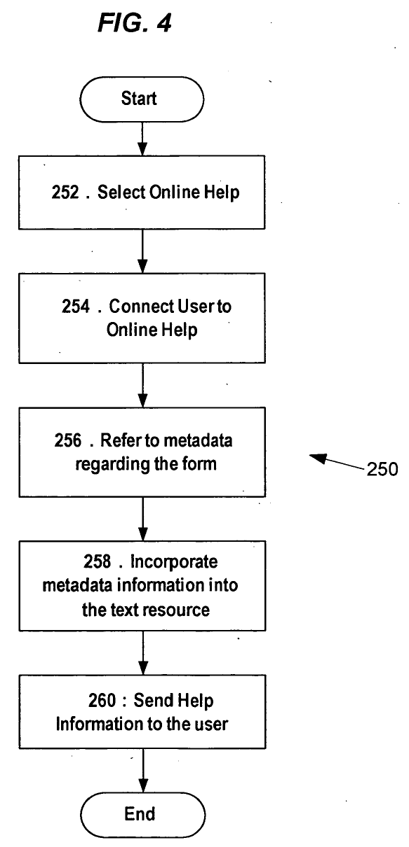

A flowchart illustrating the functioning of the online help system 200 is illustrated in FIG. 4. Specifically, FIG. 4 illustrates a flowchart of an online help program 250 using metadata to provide help related information to a form used by the application 202. Alternatively, the program 250 may be used to provide help information about other objects used by the application 202, such as a table, a function, etc.

At a block 252, a user selects to receive online help by selecting the help button 220 or by any other means. For example, in an alternate implementation online help may be accessed automatically upon occurrence of a predetermined event, such as an error committed by the user, etc. In response to the request for help, a block 254 connects the user to the online help.

Subsequently, at a block 256, the help information module 206 refers to the metadata access module 212 to get metadata information regarding the object for which help information is requested. For example, if help is requested for a form object, the program 250 may refer to the metadata access module 212 to get further information regarding the form object. The metadata access module 212 may keep up-to-date metadata information about various objects of the application 202. Thus, if the application 202 is updated by the user, the metadata stored in the metadata access module 212 may also be updated to reflect the updates made to the application 202. As a result, the help information module 206 is always able to access up-to-date information about the application 202.

After getting metadata information from the metadata access module 212, a block 258 incorporates the metadata information about the application 202 into text resources necessary to provide the help information. The text resources can be accessed from the text resource module 210. The conversion module 214 may be used to convert the metadata information about the application 202 in a manner so that resulting information can be incorporated into the text resources obtained from the text resources module 210. Subsequently, a block 260 sends the necessary text resource, along with the. information pointed to by the metadata, which together provide the help information to the user, to the application 202. The application 202 may display such help information to the user on the graphical user interface 216.

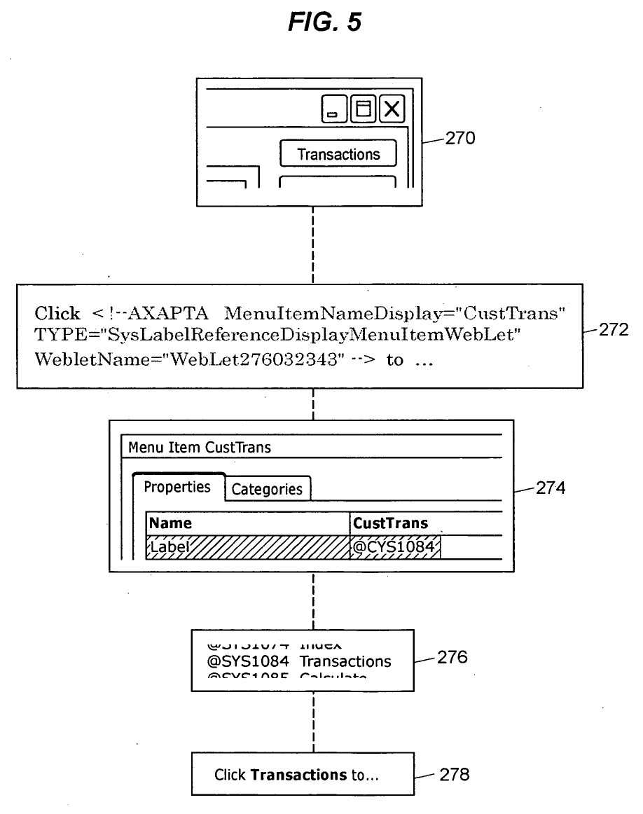

An example of the functioning of the online help program 250 is illustrated in FIG. 5. Specifically, FIG. 5 illustrates various screen views and various parts of the online help system 200 during a typical use of the online help program 250. A block 270 illustrates a screen shot of a particular form that may be displayed on the GUI 216. As illustrated by the block 270, a menu item CustTrans is rendered on the GUI by a top-right button, presently labeled as “Transactions.” However, a user of that particular form may change the name of the menu item CustTrans to be displayed as something else, such as “Payment,” etc. When a user makes such a change, the metadata of that particular form is updated to reflect such a change.

A section of text, addressing use of the menu item CustTrans, as stored in the text resources module 210 is shown in a block 272. Specifically, the block 272 illustrates that instead of referring directly to the text of the menu item CustTrans, as displayed on the GUI 216, the text resource module 210 refers to the metadata of the menu item CustTrans. Thus, when help related to the menu item CustTrans is rendered, the metadata access module 212 accesses the metadata related to the menu item CustTrans and the conversion module 214 converts the metadata into appropriate text information. This is illustrated in FIG. 5 by blocks 274-276.

The block 274 illustrates a metadata table for the menu item CustTrans. As illustrated in the block 274, the label for the menu item CustTrans is stored as a memory address of @SYS1084. The block 276 illustrates that the value stored in the memory as the address @SYS1084 is “Transactions.” Thus, when the conversion module 214 converts the section of text from the block 272 according to the current metadata related to the menu item CustTrans, as shown in the Block 278, it substitutes the text “Transactions” into the help text rendered on the GUI 216.

### Metadata Driven User Interface System

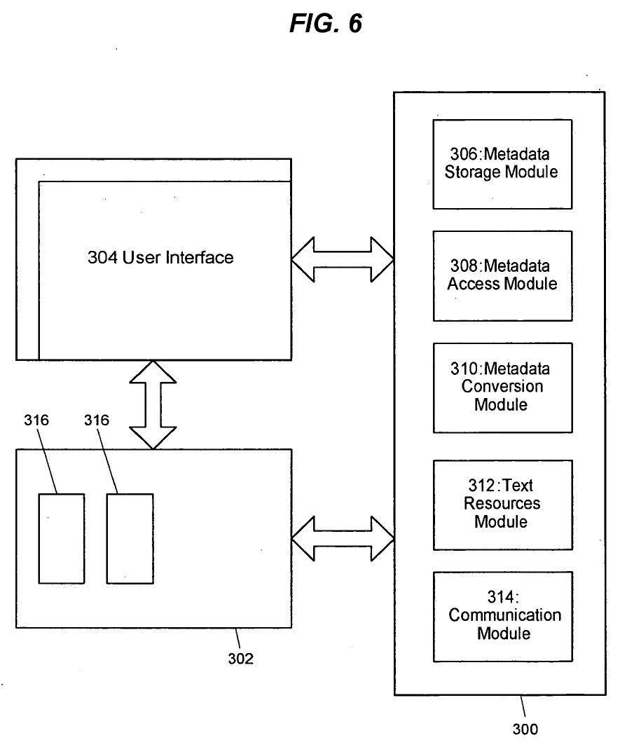

While the online help menu system 200 illustrates one application of a method of extracting metadata information from an application, an alternate application is illustrated by a metadata driven user interface system 300 of FIG. 6. Specifically, the user interface system 300 allows a change in the entity related to a particular application to be reflected automatically into a user interface used by that particular application. The user interface system 300 works with an application 302 using a user interface 304 so that anytime a change is made to an entity related to the application 302, it is reflected any window generated by the user interface 304.

Specifically, the user interface system 300 may include a metadata storage module 306, a metadata access module 308, a metadata conversion module 310, a text resources module 312 and a communication module 314. The metadata storage module 306 may store up-to-date metadata related to the various entities of various applications, such as the entities 316 of the application 302. Thus, anytime a change is made to an entity structure within the application 302, it may notify the metadata storage module 306 of such changes. The metadata access module 308 may allow various applications to access the metadata information stored in the metadata storage module 306, while the metadata conversion module 310 may convert such metadata into text information. The metadata conversion module 310 may use text information stored in the text resources module 312. Finally, the communication module 314 allows the user interface system 300 to communicate with the application 302 and the user interface 304.

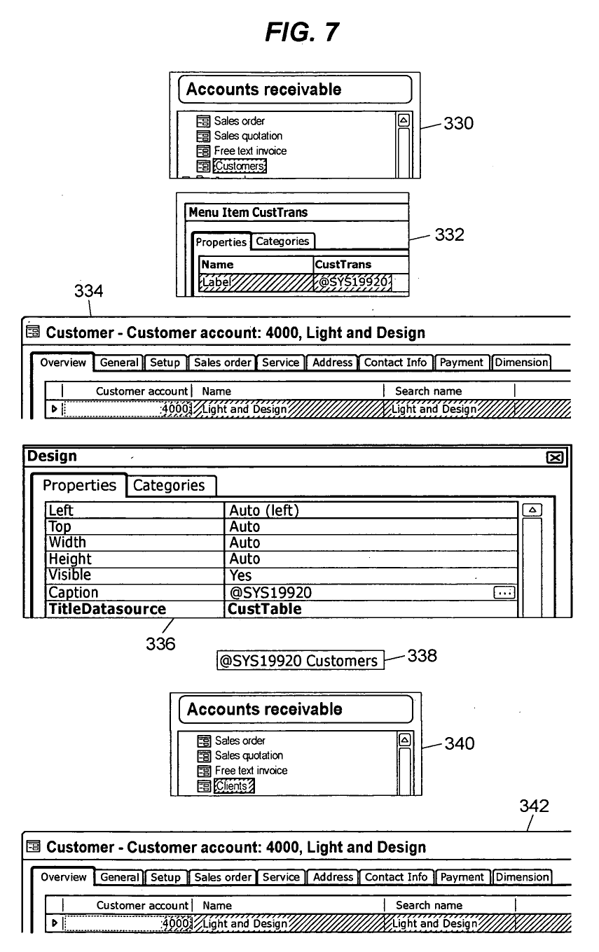

An example of the functioning of the user interface system 300 is illustrated in FIG. 7. Specifically, FIG. 7 illustrates various screen views during a typical operation of the user interface system 300. A block 330 illustrates a screen shot of a particular graphical user interface for an accounts receivable menu that may be displayed on the user interface 304. As illustrated by the block 330, a menu item Customers in the accounts receivable menu may be used to open a Customers form. The metadata related to the menu item Customers is stored in a menu item metadata table, which is called CustTable and is displayed in the block 332. The CustTable indicates that the label for the menu item Customers is defined at a memory location @SYS19920. Therefore, when a user selects the menu item Customers from the graphical accounts receivable user interface 330, a Customers form is displayed on the user interface 304.

An example Customers form is illustrated in block 334. Before displaying the Customers form, the metadata access module 308 accesses the metadata for the Customers form. An example of metadata for the Customers form is illustrated in block 336, which illustrates that the caption for the label of Customers form is stored at location @SYS19920. Subsequent block 338 illustrates that the location @SYS19920 provides the caption of the Customers form as “Customers.”

However, in an alternate scenario, a user may want to change the caption of the Customers form to “Clients” and refer to the corresponding menu item in the accounts receivable user interface 330 by “Clients.” In this case, the menu item metadata (illustrated in the block 332) and the form metadata (illustrates in the block 336) may be changed to reference a new location @SYS69369, where the location @SYS69369 may provide a text caption of “Clients.” In this case, the resulting accounts receivable user interface will have a menu item “Clients,” as illustrated in a block 340, while the Customers form user interface will have a caption of “Clients,” as illustrated in the block 342.

A person of ordinary skill in the art would appreciate the advantages of using the metadata driven online help system 200 or the metadata driven user interface system 300 described above, for a business application that may need frequent updating and custom development capabilities. Making a business application to work with metadata driven systems provides tremendous value in terms of allowing customization and support for customization, without having to redevelop the help system or the user interface system for such a business application.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

What is claimed is:

1. A method of referencing an entity of a first application in a second application, the method comprising:
defining a metadata for the entity;
providing the second application with an access to the metadata; and
inserting a reference to the metadata in the second application.

2. A method of claim 1, further comprising updating a text resource generated by the second application based on the metadata.

3. A method of claim 1, wherein the first application and the second application are communicating with each other via the Internet.

4. A method of claim 1, wherein the second application is a user interface application providing user interface to the first application.

5. A method of claim 1, further comprising updating the metadata for the first entity upon a change related to the entity in the first application.

6. A method of claim 1, wherein the second application is an online help application providing help information regarding the first application.

7. A method of claim 6, wherein a user of the first application accesses an online help module within the second application via a universal resource locator embedded in the first application.

8. A method of claim 7, further comprising:
receiving a request for a text resource regarding help information for the first entity;
receiving the reference to the metadata;
receiving a text resource reference for the text resource;
requesting text resource as specified by the text resource reference; and
receiving the text resource.

9. A metadata driven system for providing a reference for an entity of a first application in a second application, the system comprising:
a metadata definition module adapted to define a metadata for the entity;
a metadata access module adapted to provide the second application with an access to the metadata; and
a metadata conversion module adapted to insert a reference to the metadata in the second application.

10. A system of claim 9, further comprising a text update module adapted to update a text resource generated by the second application based on the metadata.

11. A system of claim 9, wherein the first application and the second application are further adapted to communicate with each other via the Internet.

12. A system of claim 9, wherein the second application is a user interface application providing user interface to the first application.

13. A system of claim 9, further comprising a metadata update module adapted to update the metadata for the first entity upon a change related to the entity in the first application.

14. A system of claim 9, wherein the second application is an online help application providing help information regarding the first application.

15. A metadata driven user interface system for providing a user interface to an application, the system comprising:
a metadata storage module adapted to store metadata related to the application;
a metadata access module adapted to access the metadata;
a metadata conversion module adapted to convert the metadata into a text resource;
a text resource module adapted to store user interface information; and
a communication module adapted to communicate with the application and the user interface.

16. A system of claim 15, further comprising a metadata update module to update the metadata in response to a change in the application.

17. A system of claim 15, wherein the application is at least one of (1) a customer relation management application; (2) a human resource application; (3) an accounting application; (4) an inventory management application; (5) a payroll application; (6) a project management application; and (7) a customer self-service application.

18. A system of claim 15, wherein the communication module is adapted to communicate with the application using the Internet.

19. A system of claim 15, further adapted to provide a plurality of user interfaces to a plurality of applications.

20. A system of claim 15, wherein the metadata is related to at least one of: (1) a form; (2) a table; (3) a process; (4) a relationship; (5) a report; (6) a menu; and (7) a menu item of the application.
